(19) United States
(12) Patent Application Publication
(10) Pub. No.: US 2017/0140425 A1
(43) Pub. Date: May 18, 2017

(54) A Media Player

(71) Applicant: Preceptiv Limited, Manchester (GB)

(72) Inventors: Andrew Ko, Cheshire (GB); David Ko, Mississauga (CA)

(21) Appl. No.: 15/323,123

(22) PCT Filed: Jun. 30, 2015
(86) PCT No.: PCT/GB2015/051909

§ 371 Date: Dec. 30, 2016

(30) Foreign Application Priority Data
Jun. 30, 2014 (GB) 1411633.9

(51) Int. Cl. G06Q 30/02

(52) U.S. Cl. CPC G06Q 30/0251; G06Q 30/0277

(57) ABSTRACT

A media player comprising a media usage module, a media usage analysis module, and an indicator. The media usage module is operable to monitor media usage over a time period and output media usage data including media genre type. The media usage analysis module is configured to derive one or more first user characteristics from the media usage data over the time period based on a user characteristic-to-genre association. The indicator module is configured to output one or more user characteristic indicators over the time period based on the derived one or more first user characteristics.

### FIELD

The invention relates to a media player. In particular, but without limitation, this disclosure relates to a media player for providing enhanced electronic notifications.

### BACKGROUND

Electronic notifications such as emails, push notifications, text messages, and instant messaging are used to convey information to users of a media player. Advertisers often use such electronic notifications to market goods and services. However, users of media players are often not concerned by such notifications, particularly when they are irrelevant to their current needs and/or ill-timed. Increasing the frequency of the notifications is a brute force way of drawing attention from the user but this does not necessarily deliver the desired marketing effect, and indeed may pester the user into not wanting the goods or services offered. Enhancing the visual appeal of the notifications offers another way of drawing attention from the user but can be highly resource intensive and may still be considered irrelevant and/or ill-timed by the user.

### SUMMARY

Aspects and features of an invention are set out in the claims.

As a result of the claimed approach more effective notifications are achieved by selectively sending messages based on a measure of a time when a user would be most receptive to certain types of notifications.

### BRIEF DESCRIPTION OF THE DRAWINGS

Examples of the present disclosure will now be described with reference to the accompanying drawings in which:

FIG. 1 shows a representation of a system which includes a network, such as a wireless local area network (WLAN), within which a media player may operate;

FIG. 2 shows exemplary block diagram of the media player;

FIG. 3 shows a flow diagram illustrating the steps of a method according to the present disclosure;

FIG. 4 shows a table illustrating the user characteristic data in relation to the media genre data, together with the processed aggregated data as handled by the media player;

FIG. 5 shows an image of a constructed user profile on an application using the received user characteristic indicators from the indicator module together with the results of whether or not to send a notification from the notification module;

FIG. 6 shows an exemplary block diagram of the media player which may operate with the network.

### DETAILED DESCRIPTION

In the present disclosure, a media player derives, from media player usage, user characteristic indicators, such as indications of a user's personality traits over a given period of time, to indicate whether or not to send a notification to the user of the media player, and the type of notification to send.

The media player comprises a media usage module, media usage analysis module, and an indicator module. The media usage module is operable to monitor media usage over a time period and output media usage data including media genre type. The media usage analysis module is configured to derive one or more first user characteristics from the media usage data over the time period based on a user characteristic-to-genre association. The indicator module is configured to output one or more user characteristic indicators over the time period based on the derived one or more first user characteristics.

The user characteristic-to-genre association may in examples be a music genre-to-personality trait association.

According to one classification system, an individual's personality may be characterised in terms of the Big Five personality trait dimensions: Openness, Conscientiousness, Extraversion, Agreeableness, and Neuroticism. The acronym OCEAN is commonly used to refer to five traits collectively. Each of the five OCEAN personality dimensions reflects variation in a distinct motivational system: open individuals value creativity, innovation, and intellectual stimulation; conscientious individuals value achievement, order, and efficiency; extraverts are especially sensitive to rewards and social attention; agreeable individuals value communal goals and interpersonal harmony; neurotic individuals are especially sensitive to threats and uncertainty. The association of a user's OCEAN personality dimension to media genre type may be based on feedbacks to these particular personalities to a particular media genre type (see, for example, references: Dunn P G et al, “Toward a better understanding of the relation between music preference, listening behaviour, and personality”, Psychology of Music 2012 40: 411 originally published online 16 Mar. 2011; Hirsh J B et al, “Personalized Persuasion: Tailoring Persuasive Appeals to Recipients' Personality Traits”, Psychological Science published online 30 Apr. 2012).

The media player may further comprise a notification module operable with the indicator module and configured to determine whether or not to send a notification to the user of the player based on the one or more user characteristic indicators.

The notification module may be further configured to inform an application the result of whether or not to send a notification to the user of the player.

In response to determining to send a notification to the user of the player, the notification module may also be configured to select one or more notifications from a library of possible notifications based on the one or more personality indicators.

The media player thus provides a measurement of the user's characteristics over a given time period, such as the user's OCEAN personality profile, to advantageously identify a period of time when the user would be most receptive to a notification, and moreover to identify the type of notification most suited to the user's current characteristics. In this way, the media player advantageously aligns the notification with the user's measured characteristic profile to provide custom-tailored notifications. Notifications are more effective when they are custom-tailored to reflect the interests and concerns of the user. Furthermore, notifications that are congruent with an individual's motivational orientation are processed more fluently and evaluated more positively than incongruent notifications. Unlike one-size-fits-all notifications, tailored notifications offer customisation and adaptation to the unique personality traits of the user with time to provide more relevant and well-timed notifications which users will be more receptive to.

For simplicity and clarity of illustration, reference numerals may be repeated among the figures to indicate corresponding or analogous elements.

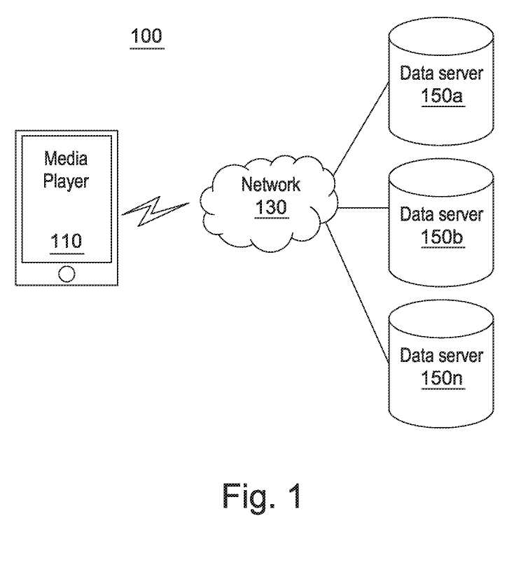

FIG. 1 illustrates an example of a system 100 having a media player 110. The system 100 comprises a network 130 through which the media player 110 may communicate. The system 100 further comprises a plurality of data servers 150a-150n arranged to store data, and also retrieve and provide data. The media player 110 is connected to the data servers 150a-150n via the network 130 in an arrangement wherein information may be conveyed from the media player 110 to one or more data servers 150a-150n, and vice versa.

The media player 110 may comprise one or more processing modules arranged to execute computer readable instructions as may be provided to the media player 110 via one or more of: a transceiver 250 arranged to enable the media player 110 to communicate with the network 130 and/or other electronic players; a plurality of input interfaces including a keypad, touch screen, memory slot, a disk drive, and a USB connection; and one or more memory modules that are arranged to retrieve and provide data to the one or more processing modules both instructions and data that have been stored in the memory.

During operation, the media player 110 connects to the network 130 to enable two-way communication with one or more of the data servers 150a-150n. For example, the media player 110 may connect to the network 130 and send an instruction to one of the data servers 150a-150n to stream specific media data stored thereon. In response to receiving the instruction, the data server retrieves the specific media data and streams it to the media player 110 via the network 130. In a further example, the media player 110 connects to the network 130 and sends data to one or more of the data servers 150a-150n, together with instructions to store the data. In response to receiving the instruction, the data server stores the received data.

As one possibility, the media player may provide data relating to its media characteristics and behaviour (such as media library data, media usage data, context data, and/or app usage data) to one or more of the data servers 150a-150n for storage. The one or more of the data servers 150a-150n may subsequently distribute the data back to the media player or to one or more other media players which are in communication with the one or more data servers 150a-150n. Additionally or alternatively, the one or more of the data servers 150a-150n may process the data first and then subsequently distribute the processed data back to the media player or to one or more other media players which are in communication with the one or more data servers 150a-150n.

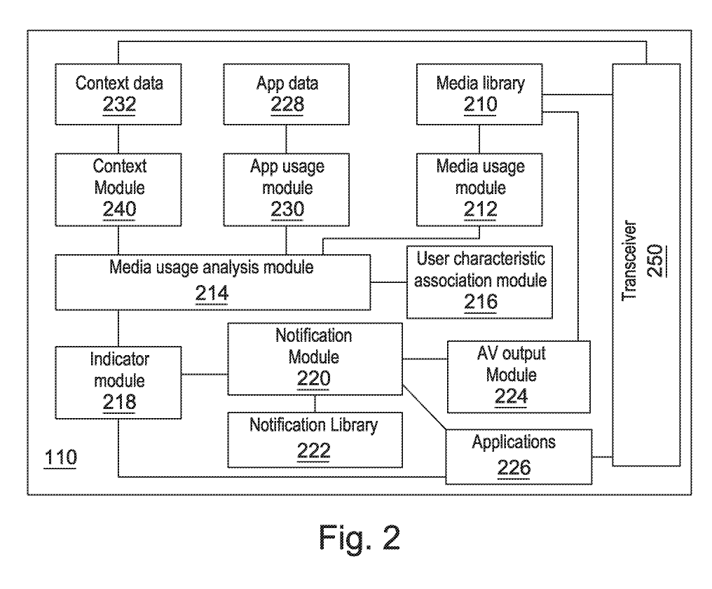

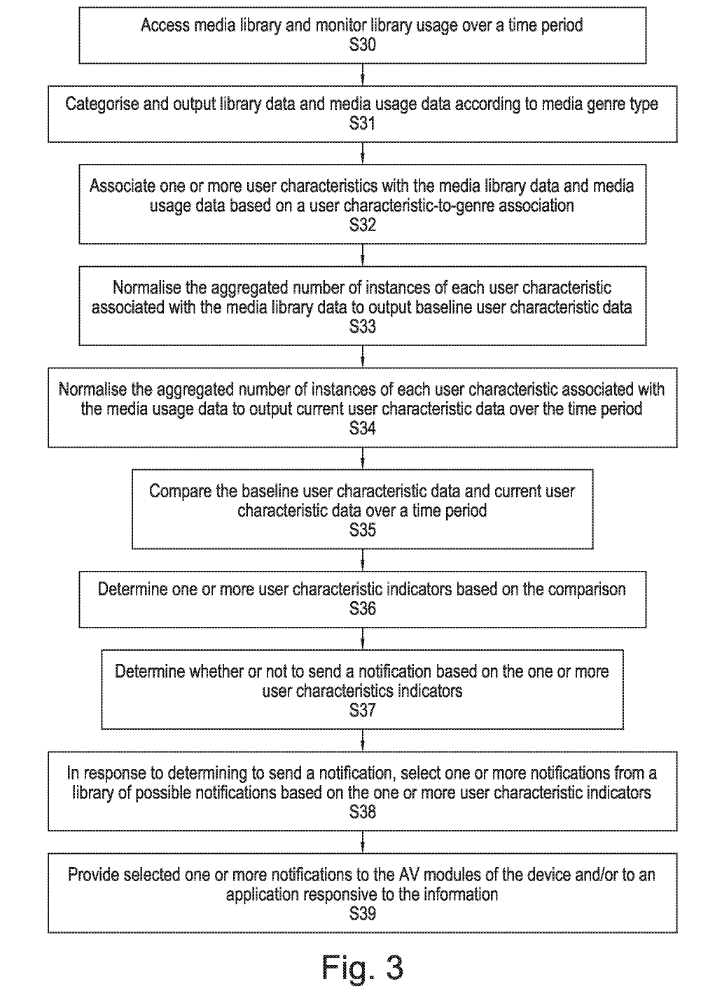

The media player 110 is enabled to maintain data synchronization with at least one of the data servers (e g. 150a) for data stored on the media player 110. A function of the media player 110 and the server may be or include, for example, a notification application program for the communication of messages. In this case, the data synchronization is a message synchronization of the types of messages for communicating with the user of the media player 110. The data synchronization may alternatively or additionally be or include media synchronization of media library data in the media module, or application synchronization of applications 226 stored on the player. These and other functions of the media player 110 are also identified later in relation to FIG. 2-3.

The network 130 may be a cellular network or alternatively a wireless network, wired network, peer-to-peer network, internetworks—for example the internet, intranetwork, or any other data network. In particular, the network may provide for access to the Internet, and/or cellular communication services.

Although the above communication has been described in terms of sending or retrieving data and/or instructions, the media player 110 and data servers 150a-150n may, additionally or alternatively, be configured to provide applications, notifications, and/or functionality.

Examples of the types of messages include, but are not limited to: emails, push notifications, pop-up messages, instant messaging, audio messaging. SMS, video messaging, multimedia messaging, and peer-to-peer messaging.

Examples of media players include, but are not limited to: smart phones, MP3 players, cellular devices, tablet computers, laptop computers, and desktop computers.

FIG. 2 shows an exemplary block diagram of components of the media player 110 in accordance with the present disclosure. The media player 110 comprises a: media usage module 212 operable to monitor media usage on the media player device 110 over a time period and output media usage data including media genre type; a media usage analysis module 214 configured to derive one or more first user characteristics from the media usage data over the time period based on a user characteristic-to-genre association; and an indicator module 218 configured to output one or more user characteristic indicators over the time period based on the derived one or more first user characteristics.

The media usage module 212 may be further coupled to access a media library 210 and operable to output media usage data and media library data, including media genre type. The media library 210 is coupled to an AV output module 224 and configured to provide media content to the AV output module 224. The AV output module 224 is arranged to provide audio, video and images to the user of the media player 110.

The media player 110 may further comprise, a context module 240 operable to access context data 232 associated with the player's operating environment over a time period and output context data 232 including context type to the media usage analysis module 214.

The media player 110 may further comprise: an app usage module 230 operable to monitor app data 228 on the media player 110 to output app usage data including app type to the media usage analysis module 214.

The media usage analysis module 214 may be coupled to the media usage module 212, app usage module 230, context module 240, and a user characteristic association module 216. The media usage analysis module 214 may also be configured to derive one or more third user characteristics from the app usage data over a time period based on a user characteristic-to-app type association obtained from the user characteristic association module 216.

The indicator module 218 may be coupled to the media usage analysis module 214 and to one or more applications 226 running on the media player 110. The indicator module 218 may be also configured to output one or more user characteristic indicators based on the derived one or more first, and/or second, and/or third user characteristics. The user characteristic indicators are sent to a notification module 220 and/or one or more applications 226.

A media player 110 may further comprise a notification module 220 operable with the indicator module 218 and configured to determine whether or not to send a notification to the user of the player based on the one or more received user characteristic indicators from the indicator module 218. The notification module 220 may also be configured to inform an application 226 the result of whether or not to send a notification to the user of the player. Further, the notification module 220 may, in response to determining to send a notification to the user of the player, select one or more notifications from a notification library 222 of possible notifications based on the one or more personality indicators. Further still, the notification module 220 may be configured to subsequently send the selected one or more notifications to an AV output module 224 of the player 110.

The transceiver 250 of the media player 110 may be coupled to the media library 210, one or more applications 226, and context data 232.

During operation, over a given time period or slot, the media usage module 212 accesses the media library 210 and monitors all types of media played on the media player 110, such as audio, video, text, and streamed media feeds. The audio files and video files may be selected from and provided by the media library 210. The media usage module 212 analyses the played media, together with the media stored in the media library 210 to determine the attributes of each played and stored media file by, for example, analysing metadata associated with the media files. The acquired attributes are used to associate genre types to each played and stored song. The media usage module 212 subsequently categorises the played media files according to media genre type and outputs the result, including media genre type, as media usage data. The media usage module 212 further subsequently categorises the stored media files according to media genre type and outputs the result, including media genre type, as media library data.

The term metadata used herein is used to describe attributes associated with a media file or app, such as, genre, title, length, artist, language, size, data rate, and publisher.

The term genre used herein is used to denote a style or category of media or app, for example music, text, audio, visual, or functionality based on some set of stylistic criteria. Genres are formed by conventions that change over time, including the addition and removal of genres. Media files and apps may be categorised into one or more genres. Possible media genre types include, hip hop, jazz, electronic, mixed tape, R&B, classics, rap, and indie. Possible app genre types include kids, games, educational, leisure, and work.

The compiled media usage data and media library data report on the user's activity history, and can, additionally or alternatively, be used to identify the user. Specifically, in preferred embodiments, the media library data is used as a signature to identify and track the user. The media usage data, alone or in combination with media library data, is used to provide notification of the user's previous activities. When a user accesses an application or website, the media usage data and media library data are sent from the media player to the application or website and stored in accessible memory. When a user accesses the application or website at a subsequent time, the application or website is configured to recognise the user based on the stored media usage data and/or media library data. Furthermore, by analysing the media usage data, it is then possible for the application or website to find out which media files the user has played, in what sequence, for how long, and what genres they were. In a specific embodiment, the media player is a smart phone, and the collected media library data, media usage data and analysis thereof is used as basis for sending notifications to the user, in addition to tracking and identifying the user.

The media usage analysis module 214 derives characteristics of the user of the media player 110. Specifically, the media usage analysis module 214 derives one or more user characteristics based on a user characteristic-to-genre association. By examining the relationship between music and user characteristic, such as user personality, a measure of the user's characteristic over a time period is obtained. In this way, user characteristics are determined based on the correlation between played music and exhibited user characteristic. The associations may be based on receptive feedback, and can use predetermined mappings between media genre and personality trait, such as OCEAN personality traits.

For example, the media usage analysis module 214 may use media genre type data, together with a music genre-to-personality trait association, to derive an individual's current personality trait profile over a particular time period.

Following determination of the media usage data and media library data, the media usage analysis module 214 derives one or more first user characteristics from the media usage data over the time period based on a user characteristic-to-genre association. In addition, the media usage analysis module 214 derives one or more second user characteristics from the media library data over the time period based on a user characteristic-to-genre association, for example in terms of OCEAN dimensions.

During operation the indicator module 218 processes the derived user characteristics outputted from the media usage analysis module 214 over a time period to provide one or more user characteristic indicators. The process to derive the user characteristic indicators comprises tabulating each type of derived user characteristic over the time period, and subsequently aggregating the number of instances each type of user characteristic is exhibited over the time period. Following the aggregation, the indicator module 218 may subsequently normalise the aggregated data, for example, with respect to the total instances of all user characteristics exhibited over the time period. The normalised data provides a weighted distribution of each type of exhibited user characteristic over the time period. The indicator module 218 may use this weighted distribution of user characteristics to determine one or more personality indicators over the time period. For example, the weighted distribution may indicate 10% of type O user characteristic, 2% of type C user characteristic, 40% of type E user characteristic, 44% of type A user characteristic, and 4% of type N user characteristic. The indicator module 218 may then analyse this distribution based on a baseline distribution and/or other criteria, such as threshold values and combination patterns, to determine a user characteristic indicator.

The indicator module 218 outputs one or more user characteristic indicators over the time period based on the derived one or more first and second user characteristics. Specifically, the indicator module 218 normalises the aggregated number of instances of each first user characteristic associated with the media usage data over the time period. This resulting weighted distribution provides current user characteristic data over the time period. The indicator module 218 also normalises the aggregated number of instances of each second user characteristic associated with the media library data. This resulting weighted distribution provides baseline user characteristic data. Following the determination of these distributions, the indicator module 218 compares the current user characteristic data with the baseline user characteristic data to determine the extent of any deviations in the weighted distribution values for each type of user characteristic. Subsequently, the indicator module 218 analyses the comparison, including current user characteristic data and baseline user characteristic data, based on criteria conditions, such as threshold values and combination patterns, to determine indicators of the user's current characteristics, such as personality. The indicator module 218 outputs this result, including current user characteristic data and baseline user characteristic data, as user characteristic indicator data. In embodiments, the user characteristic data is in terms of OCEAN dimensions. Accordingly, the indicator module 218 may determine a type E+ user characteristic indicator based on criteria which specifies that this type of behaviour occurs when the current user characteristic data comprises a type E value of >30%, in combination with the type E value being 5% below the corresponding type E value in the baseline user characteristic data. As another example, the indicator module 218 may determine a type E+O− user characteristic indicator based on criteria which specifies that this type of behaviour occurs when the current user characteristic data comprises a type E value of >30%, and type O value of <22%, in combination with the type E and type O values both being 10% above the corresponding type E and type O value in the baseline user characteristic data.

As one possibility, the indicator module 218 may additionally aggregate and normalise the derived user characteristics outputted from the media usage analysis module 214 over a second time period to provide one or more user characteristic indicators. In examples, the second time period may be the period starting from the time the media player was initiated, to the present time. The indicator module may then subsequently analyse the normalised aggregated data over first and second time periods based on criteria conditions, such as threshold values, deviations and combination patterns, to determine indicators of the user's current characteristics, such as personality.

In an embodiment, the notification module 220 monitors the user characteristic indications and uses them to determine whether or not to send a notification to the user of the media player at all. The notification module 220 may analyse the user characteristic indication data based on one or more targeted characteristic profile. When the notification module 220 identifies an acceptable match between the user characteristic indication data and the target profile, the notification module 220 may decide that a notification should be sent to the user, or conversely, should not be sent to the user. In embodiments, the notification module analyses the user characteristic indication data based on a target characteristic profile comprising a target OCEAN profile. For example, the notification module may determine an acceptable match based on the level of OCEAN for a given time period compared to their baseline OCEAN. For example, someone who has an overall OCEAN baseline that comprises of 5% Openness would be more accepting of messages if, during 3 pm-6 pm, their Openness increases to 25%. In contrast, for someone whose Openness increased to 75% with respect to a baseline Openness of 70%, the notification module will determine not to send a notification as this target characteristic profile indicates that the user would not be receptive to notifications. Another example of when not to send a message is when the relative change between the current user characteristic data and baseline user characteristic comprises a low (0% to 4.9%) change in Agreeableness and Openness, and a high increase (>10%) in Neuroticism. Therefore, in embodiments, a ‘match’ is dependent on the relative change with time between a user's current OCEAN characteristic data and a user's baseline OCEAN characteristic data.

In response to deciding to send a notification, the notification module 220 selects one or more notifications from a library of possible notifications based on the user characteristic indication data. The notifications in the notification library 222 contain multiple types of notifications directed to one or more user characteristic indications. Notifications may feature, for example, text, images, audio, and/or video. The library contains multiple notifications directed to one or more user characteristic indications. In terms of user characteristic indications described by OCEAN dimensions, the library will contain notifications directed to one or more OCEAN dimension. For example, for a notification directed to a solely E type OCEAN user characteristic indication, the features of the notification will be directed to “extraversion” characteristics. For a notification directed to a E+O− type OCEAN user characteristic indication, the features of the notification, such as text, will be directed to “extraversion” and “openness” characteristics. For a notification directed to an OCEAN user characteristic indication profile comprising an overall 30% O, 15% C, 15% E, 10% A, and 30% N dimension, the features of the notification will be directed to each different OCEAN characteristic according to their percentage values.

As one possibility, a particular style of interest may be associated with each possible combination of user characteristic indications. Particular styles of interest include mainstream consumer interests which reflect popular favourites such as parties, sports, shopping, and blockbuster movies. For example, notifications of an E+O− OCEAN type are associated with mainstream consumers, and E+O+ are associated with creative interactors whose interests revolve around the new and different and they like to share their discoveries with others.

Again, association may be based on pre-determined mappings of genre or interest to one or a combination of personality traits such as OCEAN traits.

The notification module 220 searches the notification library to look for notifications which best match the user characteristic indication data provided by the indication module. Subsequently, the notification module selects the one or more closest matching notifications. The selected one or more notifications are provided to the AV module. Additionally or alternatively, the selected one or more notifications may be sent to an application 226 on the media player 110. Further additionally or alternatively, the notification module 220 may send the decision of whether or not to send a notification to the application 226.

As one possibility, the closest matching notification may be based on percentage matching criteria, such as a maximum percentage deviation (e.g. a maximum 5% absolute deviation) between the user characteristic indications associated with a notification and the user characteristic indications provided by the indication module.

As one possibility, when one or more notifications are deemed to be suitable, the notification module 220 may additionally or alternatively select one or more notifications based on a record of what past notifications have been sent and which have caused a user response. For example, in the case of a past response which has caused a positive user response, such as when the user clicks on a link which is featured in the notification, the notification module 220 will select a notification which is similarly themed or has the same one or more user characteristic indications. Conversely, in the case of a past response which has caused a negative user response, such as when the user closes the notification, the notification module 220 will not select a notification which is similarly themed or has the same one or more user characteristic indications. If there is no past information, a random notification will be selected and tracked to learn whether or not the notification causes a positive user reaction. Subsequently, record data comprising details of the sent notification including whether or not the notification caused a positive or negative reaction is recorded on the media player 110. Additionally or alternatively the record data may be sent to a data server for storage (e.g. 150a) and subsequent retrieval by the media player 110.

As one possibility, the notification module 220 may decide to send a notification and select a notification based on a record of what kinds of notifications the user has responded to in the past in certain contexts. For example, if a user has responded positively to E+O− OCEAN type notifications on Friday's at 9 pm, the notification module 220 will decide to send a notification which is similarly themed or has the same one or more user characteristic indications. If a user has only clicked on 10% of all O+C− notifications sent to them on Monday's at 9 am, the notification module 220 will not send a notification which is similarly themed or has the same one or more user characteristic indications. Subsequently, record data comprising details of the selected notification including whether or not the notification caused a positive or negative reaction is recorded on the media player 110. Additionally or alternatively the record data may be sent to a data server (e.g. 150a) for storage and subsequent retrieval by the media player 110.

As one possibility, if the notification module cannot select a notification, it may either not send a message, or alternatively select a random notification and track the user's response to the notifications, such as determining whether the user has watched the entire message.

The AV output module 226 outputs the notification to the user via an audio and/or display output associated with the media player 110.

Advantageously, the media player 110 determines a user's media behaviour to discern the user's characteristics, such as OCEAN personality characteristics, to identify a period of time when the user would be most receptive to a notification directed to a certain type of user characteristic. That is, the media player 110 provides a measurement of the user's characteristics, such as OCEAN personality trait, as a means to provide more relevant notifications and at an opportune time when the user would be receptive and welcoming of the notification.

In this way, the media player advantageously aligns the notification with the user's measured characteristic profile to provide custom-tailored notifications. Notifications are more effective when they are custom-tailored to reflect the interests and concerns of the user. Furthermore, notifications that are congruent with an individual's motivational orientation are processed more fluently and evaluated more positively than incongruent notifications. Unlike one-size-fits-all notifications, tailored notifications offer customisation and adaptation to the unique personality traits of the user with time to provide more relevant and well-timed notifications which users will be more receptive too.

Notifications include emails, app push notifications, pop-up messages, instant messaging, audio messaging, video messaging, SMS, multimedia messaging, and peer-to-peer messaging.

Although the above has been described with respect to media usage data and media library data, other approaches could equally be used. For example, the media usage module 212, media usage analysis module 214, and indicator module 218 could operate to only determine the media usage data and one or more first user characteristics to derive one or more user characteristic indicators. Additionally or alternatively, the indicator module 218 may, instead of aggregating and/or normalising the number of instances of each first and/or second user characteristic, use any other technique to derive user characteristic indicators.

As one possibility, the application usage module may be used to access app data 228 and/or applications 226 on the media player 110, such as an internet browser, gaming app, map app, and camera app, to determine app usage data including attributes of the app, such as metadata. The app usage module 230 uses this data to determine app type and subsequently categorises the apps according to app type and outputs the result, including app type, as app usage data.

Subsequently, as with deriving one or more first and second user characteristics, the media usage analysis module 214 derives one or more third characteristics from the app usage data over the time period based on a user characteristic-to-app type association. Further subsequently, the indicator module 218 then determines one or more user characteristic indicators further based on the derived one or more third user characteristics.

Additionally or alternatively, the app usage module 230 may use the app usage data to set the time period to a period of time relating to the app usage data.

As another possibility, the context module 240 may be used to access context data 232 associated with the media player's operating environment to output context data 232 including context type. The context module may subsequently determine a period of time relating to a one or more context types and set that as the period of time used by the media player including the media usage module 212, media usage analysis module 214, indicator module 218, and notification module 220.

The above operations have been described in relation to a period of time. The period of time may, for example, be a 3 hour window in the day. Additionally or alternatively, the period of time may be set by the context module 240 as a period of time relating to a one or more context types, for example, the period of time when it is sunny or rainy in the day. Further additionally or alternatively, the period of time may be set by the app usage module 230 as a period of time relating to a one or more app types, for example, the period of time associated with the usage of social or shopping applications in the day.

Examples of context data 232 include date, time, weather, location and temperature. Such context data 232 may be provided to the media player 110 via sensors in communication with the media player 110, or as information provided to the media player 110 from the network 130.

As another possibility, the media player 110 may send media usage data including media genre type, media library data including media genre type, user characteristic indicators, context data including context type, app usage data including app type, the decision of whether or not to send a notification, and the selected one or more notifications to the one or more data servers 150a-150n for storage. The one or more data servers 150a-150n for storage may collect data from a plurality of media devices connected to the servers.

In embodiments, during operation, when the media player is unable to determine media usage data including media genre type, the media player 110 may send media library data including media genre type to the one or more data servers 150a-150n and request the media usage data including media genre type of another media device which has the same, or closest match to, the sent media library data. In response, the one or more data servers 150a-150n sends the requested information to the media device 110. Upon receipt of the requested data, the media player subsequently processes the media usage data including media genre type to derive user characteristic indicators, and determine whether or not to send a notification, and the selected one or more notifications using the approaches described herein.

In embodiments, during operation, when the media player is unable to determine media usage data including media genre type, and media library data including media genre type, the media player 110 may send context data including context type to the one or more data servers 150a-150n and request the media usage data including media genre type, and/or the media library data including media genre type of another media device which has the same, or closest match to, the sent context data. In response, the one or more data servers 150a-150n sends the requested information to the media device 110. Upon receipt of the requested data, the media player subsequently processes the received data to derive user characteristic indicators, and determine whether or not to send a notification, and the selected one or more notifications using the approaches described herein.

Additionally or alternatively, the requested data may also include app usage data including app type, the decision of whether or not to send a notification, and the selected one or more notifications.

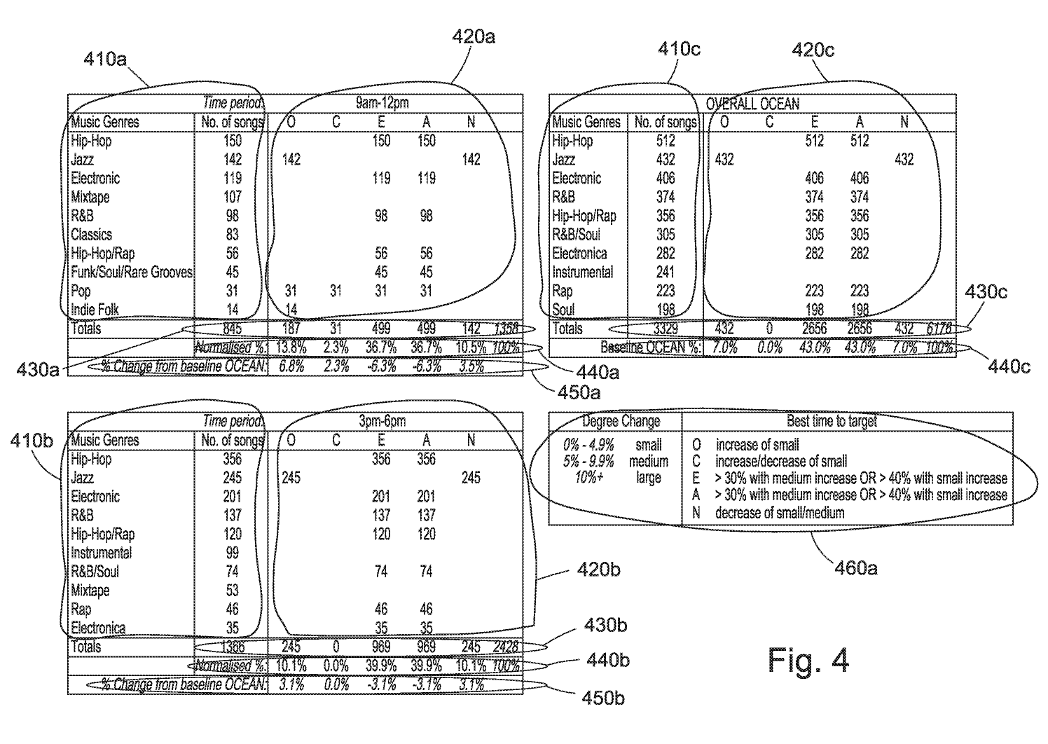

FIG. 3 shows a flow diagram illustrating the steps of a method according to the present disclosure, and will be described herein with reference to FIG. 4.

At step S30, the media usage module 212 accesses the media library 210 and monitors library usage over a time period.

At step S31 the media usage module 212 categorises and outputs media library data and media usage data according to the media genre type. As can be seen in FIG. 4, the media usage module 212 has categorised the played media files according to media genre type as media usage data over time slots 9 am-12 pm (circled hoop 410a) and 3 pm-6 pm (circled hoop 410b). In addition, the media usage module 212 has categorised the stored media files in the media library 210 according to media genre type (circled hoop 410c) as media library data.

At step S32 the media usage analysis module 214 associates one or more user characteristics with the media library data and media usage data based on a user characteristic-to-genre association. As can be seen in FIG. 4, for media usage data during 9 am-12 pm and 3 pm-6 pm, the media usage analysis module has associated OCEAN personality traits to every played media file and aggregated the results according to media genre type (circled hoops 420a and 420b). In addition, for the media library data, the media usage analysis module has associated OCEAN personality traits to every stored media file in the media library and aggregated the results according to media genre type (circled hoops 420c).

At step S33, the indicator module 218 normalises the aggregated number of instances of each user characteristic associated with the media library data to output baseline user characteristic data. As can be seen in FIG. 4, the indicator module has aggregated number of instances (430a, 430b) of each OCEAN characteristic associated with the media library data (430c). The indicator module 218 has also normalised the aggregated number of instances of each OCEAN characteristic associated with the media library data to output baseline user characteristic data (440c).

At step S34, the indicator module 218 normalises the aggregated number of instances of each user characteristic associated with the media usage data to output current user characteristic data over the time period. As can be seen in FIG. 4, the indicator module 218 has aggregated number of instances (430a, 430b) of each OCEAN characteristic associated with the media usage data. The indicator module has also normalised the aggregated number of instances of each OCEAN characteristic associated with the media usage module to output current user characteristic data (440a and 440b).

At step S35 the indicator module 218 compares the baseline user characteristic data with the current user characteristic data over a time period. As can be seen in FIG. 4, indicator module 218 compares the baseline user characteristic data (440c) with the current user characteristic data (440a and 440b) to determine a relative deviation over 9 am-12 pm and 3 pm-6 pm. At step S36 the indicator module 218 determines one or more user characteristic indicators based on the comparison and criteria conditions 460a. At step S37 the notification module 220 determines whether or not to send a notification based on the one or more user characteristic indicators. At step S38, in response to determining to send a notification, the notification module 220 selects one or more notifications from a library of possible notifications based on the one or more user characteristic indicators. At step S39, the notification module 220 provides the selected one or more notifications to the AV module of the media player 110 and/or to an application responsive to the information. Subsequently, the media player 110 tracks the user's response to the notification to learn whether or not the notification causes a positive user reaction. Record data comprising details of the sent notification including whether or not the notification caused a positive or negative reaction is stored on the media player 110. Additionally or alternatively the record data may be sent to one or more data servers (e.g. 150a-150n) for storage and subsequent retrieval by the media player 110.

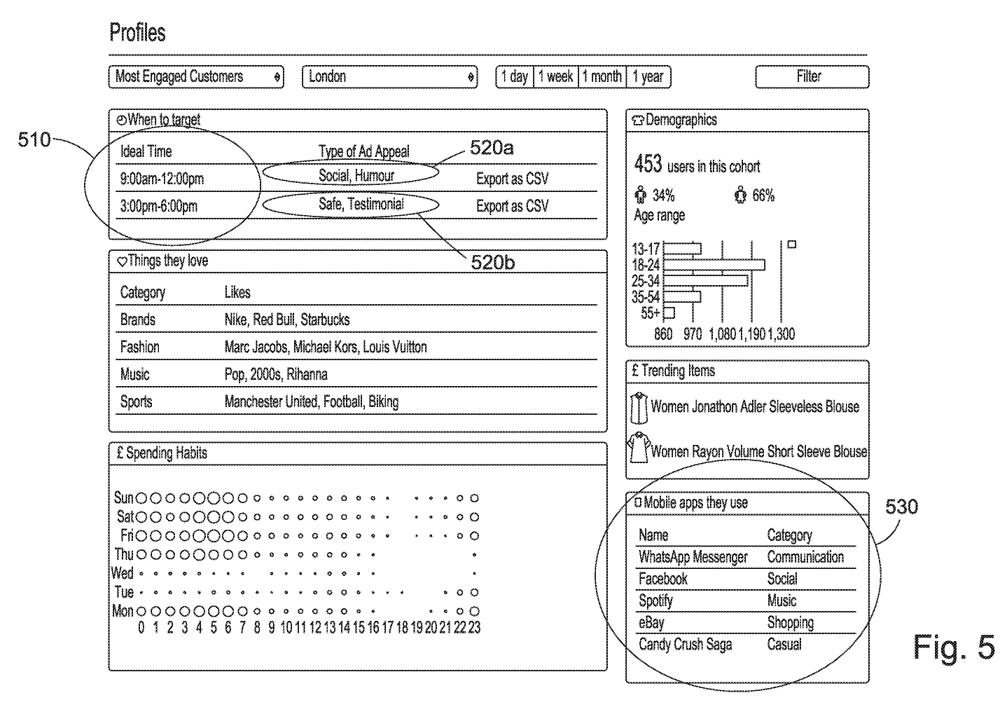

FIG. 5 shows an application 226 running on the media player 110. The application has received information on whether or not to send a notification from the notification module 220, and has subsequently processed it 510. The application has also received information from the indicator module 218 of the user characteristic indicators 520, and has subsequently processed it 510. In this example, the user characteristic indicator data 520 includes app usage date including app type (circled loop 530). At time periods 9 am to 12 pm and 3 pm to 6 pm, the notification module 220 has determined to send a notification to the user (circled loop 510). At 9 am to 12 pm, the indicator module 218 has indicated to the application 500 that the user has user characteristic indicators (circled loop 520a), indicative of social and humorous behaviour. At 3 pm to 6 pm, the indicator module 218 has indicated to the application that the user has user characteristic indicators (circled loop 520b), indicative of safe and testimonial behaviour.

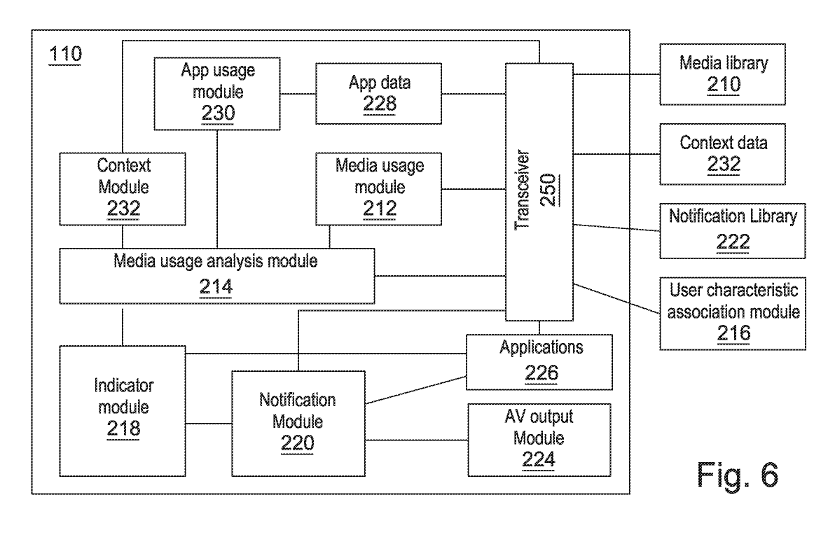

FIG. 6 illustrates an embodiment of the media player 110 wherein the media library 210, user characteristic association module 216, notification library 222, and context data 232 are alternatively located on one or more remote data servers (150a-150n). The media player is coupled to, and operable with, the media library 210, user characteristic association module 216, notification library 222, and context data 232, via the transceiver module 250.

During operation, the media usage module 212 accesses the media library 210 via the transceiver module 250 to determine media usage data and media library data. The media usage analysis module 214 accesses the user characteristic association module 210 via the transceiver module 250 to determine a user characteristic-to-genre association and derive one or more user characteristics based on a user characteristic-to-genre association. The notification module 220 accesses the notification library 222 via the transceiver module 250 to select one or more notifications from the library based on the user characteristic indication data, in response to deciding to send a notification. The context module 220 accesses the notification library 222 via the transceiver module 250 to select one or more notifications from the library based on the user characteristic indication data, in response to deciding to send a notification. The context module 240 accesses context data 232 associated with the media player's operating environment to output context data 232, including context type.

As one possibility, the media usage data and media library may be based on streamed media received at the media player via the transceiver.

As one possibility, the notification module 220 may also be located on one of the servers. During operation, the indicator module 218 sends user characteristic indicator data to the notification module via the transceiver. The notification module 220 sends the decision of whether or not to send a notification to the AV output module 224, and/or applications 226, via the transceiver. The notification module 220 also sends the selected one or more notifications to the AV output module 224, and/or applications 226, via the transceiver.

The approaches described herein may be embodied on a computer readable medium, which may be a non-transitory computer readable medium, the computer readable medium carrying computer readable instructions arranged for execution upon a processor so as to make the processor carry out any or all of the methods described herein.

The term computer readable medium as used herein refers to any medium that stores data and/or instructions for causing a processor to operate in a specific manner. Such a storage medium may comprise non-volatile media and/or volatile media. Non-volatile media may include, for example, optical or magnetic disks. Volatile media may include dynamic memory. Exemplary forms of storage medium include, a floppy disk, a flexible disk, a hard disk, a solid state drive, a magnetic tape, any other magnetic data storage medium, a CD-ROM, any other optical data storage medium, any physical medium with one or more patterns of holes or protrusions, a RAM, a PROM, an EPROM, a FLASH-EPROM, NVRAM, and any other memory chip or cartridge.

1. A media player comprising:
a media usage module operable to monitor media usage over a time period and output media usage data including media genre type;
a media usage analysis module configured to derive one or more first user characteristics from the media usage data over the time period based on a user characteristic-to-genre association; and
an indicator module configured to output one or more user characteristic indicators over the time period based on the derived one or more first user characteristics.

2. A media player as claimed in claim 1 wherein the indicator module is configured to aggregate the number of instances of each first user characteristic to determine one or more user characteristic indicators.

3. A media player as claimed in claims 1-2 wherein the aggregated number of instances is normalised.

4. A media player as claimed in claim 1 wherein the media usage module is further operable to access a media library and output media library data including media genre type.

5. A media player as claimed in claim 4 wherein the media usage analysis module is configured to derive one or more second user characteristics from the media library data based on a user characteristic-to-genre association;

6. A media player as claimed in claim 5 wherein the outputted one or more user characteristic indicators over the time period is further based on the derived one or more second user characteristics.

7. A media player as claimed in any of claims 5 or 6 wherein the indicator module is configured to aggregate the number of instances of each second user characteristic to determine baseline user characteristic data.

8. A media player as claimed in claim 7 wherein the aggregated number of instances is normalised.

9. A media player as claimed in any of claims 7-8 wherein the indicator module is configured to determine at least one difference between at least one first user characteristic and the baseline user characteristic data to determine one or more user characteristic indicators.

10. A media player as claimed in claim 1 wherein the one or more user characteristics are based on personality traits, optionally OCEAN (Openness, Conscientiousness, Extraversion, Agreeableness, Neuroticism) personality traits.

11. A media player as claimed in claims 1-10 comprising a context module operable to access context data associated with the player's operating environment and output context data including context type;
wherein the time period is the period of time relating to context data.

12. A media player as claimed in any of claims 1-10 comprising an app usage module operable to access app data on the media player to output app usage data including app type;
wherein the time period is the period of time relating to app usage data.

13. A media player as claimed in any of claims 1-10 comprising an app usage module operable to access app data on the media player to output app usage data including app type;
wherein the media usage analysis module is configured to derive one or more third user characteristics from the app usage data over the time period based on a user characteristic-to-app type association; and
wherein the indicator module is configured to output one or more user characteristic indicators further based on the derived one or more third user characteristics.

14. A media player as claimed in any of claims 1-13 comprising a notification module operable with the indicator module and configured to determine whether or not to send a notification to the user of the player based on the one or more user characteristic indicators.

15. A media player as claimed in any of claims 1-14 wherein the notification module informs an application the result of whether or not to send a notification to the user of the player.

16. A media player as claimed in any of claim 1-15 wherein the notification module, in response to determining to send a notification to the user of the player, selects one or more notifications from a library of possible notifications based on the one or more personality indicators.

17. A media player as claimed in any of claim 1-16 wherein the selected one or more notifications is sent to an AV output module of the player.

18. A media player as claimed in any of claims 1-17 wherein the media library data is sent to an application or website as a signature to identify and track the user of the media player.

19. A media player as claimed in any of claims 1-18 wherein the media usage data is sent to an application or website as a record of the user's activities.

20. A media player as claimed in any of claims 1-19 wherein the media player 110 tracks the user's response to the notification.

21. A media player as claimed in any of claims 1-20 wherein the media player 110 is configured to store record data comprising details of the sent notification including whether or not the notification caused a positive or negative.

22. A media player as claimed in claim 21 wherein the media player 110 is configured to send to a data server record data comprising details of the sent notification including whether or not the notification caused a positive or negative.

23. A media player as claimed in any of claim 1-22 wherein the selected one or more notifications is sent to the application.

24. A media player as claimed in any of claim 1-23 wherein the library of possible notifications is provided remotely and is accessible via a transceiver module located on the player.

25. A media player as claimed in any of claim 1-24 wherein the media library is provided remotely and is accessible via a transceiver module located on the player.

26. A media player as claimed in any of claim 1-25 wherein media from the media library is streamed remotely to the player.

27. A media player as claimed in any of claims 1-26 wherein the user characteristic-to-genre association is stored on remotely and is accessible via a transceiver module located on the player.

28. A media player as claimed in any of claims 1-27 wherein the user characteristic-to-app type association is stored on remotely and is accessible via a transceiver module located on the player.

29. A media player as claimed in any of claims 1-28 wherein the library of possible notifications is provided on the player.

30. A media player as claimed in any of claim 1-29 wherein the media library is provided on the player.

31. A media player as claimed in any of claim 1-30 wherein the user characteristic-to-genre association is stored locally on the player.

32. A media player as claimed in any of claim 1-31 wherein the user characteristic-to-app type association is stored locally on the player.

33. A system comprising the media player in any of claims 1-30 and:
in which the media player includes a transceiver configured to communicate information to and from the media player; and
a server comprising a database module arranged to store the media library and operable to provide media library data including media genre type to the media player.

34. A system as claimed in claim 33 comprising:
a user characteristic server comprising a database module for storing the user characteristic-to-genre association and user characteristic-to-context type association, and operable to provide user characteristic data to the media player via the communications network.

35. A system as claimed in claim 33 comprising:
a notification server comprising a database module for storing the library of possible notifications and operable to provide notification data to the media player via the communications server.

36. A system as claimed in claim 33 further comprising:
one or more other media players, each including a transceiver configured to communicate information to and from the media player to the server; and
wherein the server is configured to:
store information associated with each of the media players; and
and provide the stored information to any of the media player on request.

37. A system as claimed in claim 36 wherein the information associated with each of the media files comprises media usage data including media genre type, media library data including media genre type, app usage data including app type, the decision of whether or not to send a notification, and the selected one or more notifications.

38. A method of operating a media player comprising the steps of:
monitoring media usage on the media player over a time period to determine media usage data including media genre type;
deriving one or more first user characteristics from the media usage data over the time period based on a user characteristic-to-genre association; and
determining one or more user characteristic indicators over the time period based on the derived one or more first user characteristics.

39. A method as claimed in claim 38 wherein the step of determining one or more user characteristic indicators comprises aggregating the number of instances of each first user characteristic over the time period.

40. A method as claimed in claim 39 further comprises normalising the aggregated number of instances of each first user characteristic.

41. A method as claimed in claim 38 further comprises the steps of:
accessing a media library over the time period and determining media library data including media genre type;
deriving one or more second user characteristics from the media usage data over the time period based on a user characteristic-to-genre association; and
wherein the step of determining one or more user characteristic indicators over the time period is further based on the derived one or more second user characteristics.

42. A method as claimed in claim 40 wherein the step of determining one or more user characteristic indicators comprises aggregating the number of instances of each second user characteristic over the time period.

43. A method as claimed in claim 41 further comprises normalising the aggregated number of instances of each second user characteristic.

44. A method as claimed in any of claims 38-43 wherein the step of determining one or more user characteristic indicators comprises determining at least one difference between at least one first user characteristic and at least one second user characteristic.

45. A method as claimed in any of claim 38-44 further comprising:
accessing a context module over the time period and determining context data including context type;
setting the time period to the period of time relating to context data.

46. A method as claimed in any of claim 38-45 further comprising:
accessing an app usage module over the time period and determining app usage data including app type;
setting the time period to the period of time relating to app usage data.

47. A method as claimed in any of claim 38-46 further comprising:
deriving one or more third user characteristics from the app usage data over the time period based on a user characteristic-to-app type association; and
wherein the step of determining one or more user characteristic indicators over the time period is further based on the derived one or more third user characteristics.

48. A method as claimed in any of claims 38-47 further comprising:
determining whether or not to send a notification based on the one or more user characteristic indicators.

49. A method as claimed in any of claims 38-48 further comprising:
informing an application of the result of whether or not to send a notification.

50. A method as claimed in any of claims 38-49 further comprising:
selecting one or more notifications from a library of possible notifications based on the one or more user characteristic indicators.

51. A method as claimed in any of claims 38-50 further comprising:
sending the selected one or more notifications.

52. A computer readable medium carrying machine readable instructions arranged, when executed by a processor, to cause the processor to carry out the method of any of claims 38 to 51.

53. A media player comprising an app configured to perform the method of any of claims 38 to 51.

54. A media player comprising;
an app usage module operable to access app data on the media player over a time period to output app usage data including app type;
a media usage analysis module configured to derive one or more third user characteristics from the app usage data over the time period based on a user characteristic-to-app type association; and
an indicator module configured to output one or more user characteristic indicators over the time period based on the derived one or more third user characteristics.

55. A media player as claimed in claim 54 comprising a notification module operable with the indicator module and configured to determine whether or not to send a notification to the user of the player based on the one or more user characteristic indicators.

56. A method of implementing the steps of claims 54 to 55.

57. A computer readable medium or app configured to implement the method of claim 56.

58. A method, apparatus, system, or computer readable medium substantially as described herein and with reference to the accompanying drawings.
